(19) United States
(12) Patent Application Publication
(10) Pub. No.: US 2009/0172528 A1
(43) Pub. Date: Jul. 2, 2009

(54) SYSTEM AND METHOD FOR DYNAMICALLY PRESENTING A SOFTWARE SYSTEM LANDSCAPE

(76) Inventors: RAMPRASAD S, Bangalore (IN); Sigo Henkel, Heidelberg (DE); Paresh Deshpande, Bangalore (IN)

Correspondence Address: SAP AG, 3410 HILLVIEW AVENUE, PALO ALTO, CA, 94304, US

(21) Appl. No.: 11/967,286

(22) Filed: Dec. 31, 2007

(51) Int. Cl. G06F 3/048

(52) U.S. Cl. 715/700

(57) ABSTRACT

Embodiments of the invention are generally directed to a system and method for dynamically presenting a system landscape or software system landscape. The system landscape is monitored for changes and updates. A service is responsible for extracting and structuring the system landscape data in a presentable format. An output controller displays the system landscape data. A system landscape directory stores the system landscape data.

### FIELD OF THE INVENTION

The invention generally relates to system and method to servicing of a software system landscape, and more particularly to a method for dynamically presenting a system landscape or software system landscape.

### BACKGROUND OF THE INVENTION

Today, computers are used everywhere. They run complex software and perform several functions. Such complex software may therefore be implemented in form of separate logical systems that together form a system landscape. Typically, an organization will have several computer systems running, each such system performing a different function. At times several middleware components may be interfaced with these computer systems to enable communication amongst them.

The system landscape should be monitored continuously in real-time. When a new system is added, its information is reflected immediately for the smooth and continuous performance of the organization system landscape.

Therefore, there is a need for providing a system that can monitor the system landscape in real-time and dynamically present the system landscape information to the end user.

### SUMMARY OF THE INVENTION

Embodiments of the invention are generally directed to a system and method for dynamically presenting a system landscape or software system landscape. The system landscape is monitored for changes and updates. A service is responsible for extracting and structuring the system landscape data in a presentable format. An output controller displays the system landscape data. A system landscape directory stores the system landscape data.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a schematic block diagram illustrating an implementation, according to an embodiment of the invention.

FIG. 2 is a flow diagram illustrating a method for dynamically presenting a system landscape, according to an embodiment of the invention.

FIG. 3 is a schematic block diagram illustrating a system for dynamically presenting a system landscape, according to an embodiment of the invention.

### DETAILED DESCRIPTION

Embodiments of the invention are generally directed to a system and method for dynamically presenting a system landscape or software system landscape. The system landscape is monitored for changes and updates. A service is responsible for extracting and structuring the system landscape data in a presentable format. An output controller displays the system landscape data. A system landscape directory stores the system landscape data.

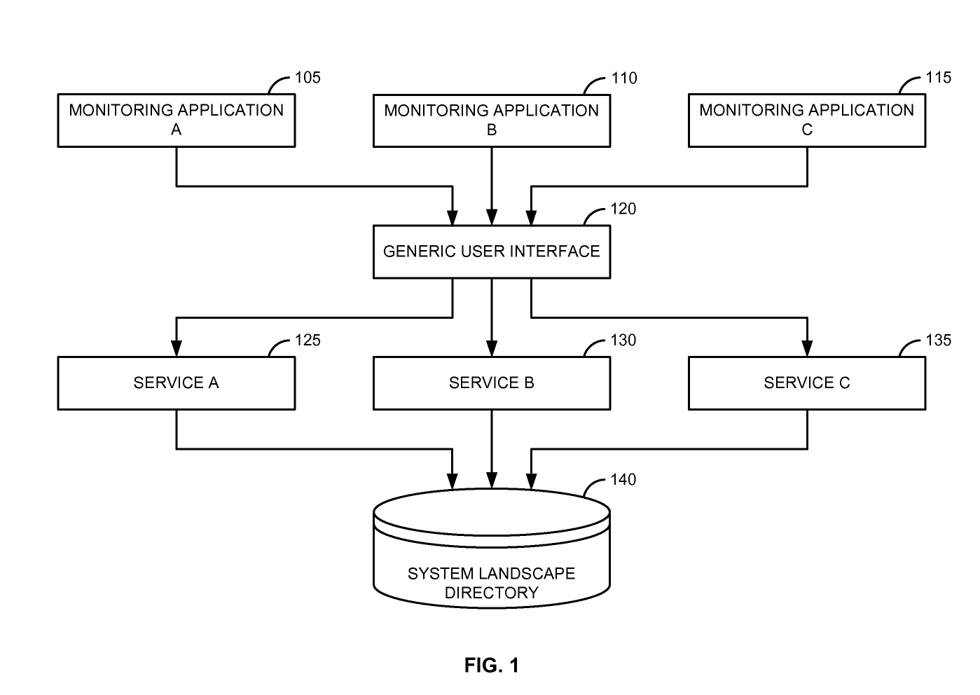

FIG. 1 is a schematic block diagram illustrating an implementation, according to an embodiment of the invention. Often software is customized in various ways, including selection of predefined functionality, adaptation and other servicing like program and data updates. The adaptation further may include addition or amendment to functionality. Before servicing is performed, it is ensured that the customization, adaptation, program and data updates are free of errors and integrate flawlessly into the software and data environment. In industries, servicing errors result in costly workflow disruptions due to software malfunction or data corruption. Hence in an organization, several software are implemented in the form of one or more separate logical systems that together form a system landscape of FIG. 1. Monitoring applications such as monitoring application A 105, monitoring application B 110 and monitoring application C 115 monitor the system landscape. In an embodiment, monitoring a system landscape continuously monitors the system landscape for changes and updates. Graphical user interface 120 displays system landscape data in a presentable format. In an embodiment, the presentable format is a generic tree structure. In an embodiment, the system landscape data is generated using a data processing service. Further, the system landscape data includes content and is associated with a presentable format. Services such as Service A 125, Service B 130, Service C 135 are responsible for extracting and structuring a context specific tree of the system landscape data. Further, structuring the system landscape data in a presentable format includes constructing the context specific tree. System landscape directory 140 persists the system landscape data within a heterogeneous system landscape.

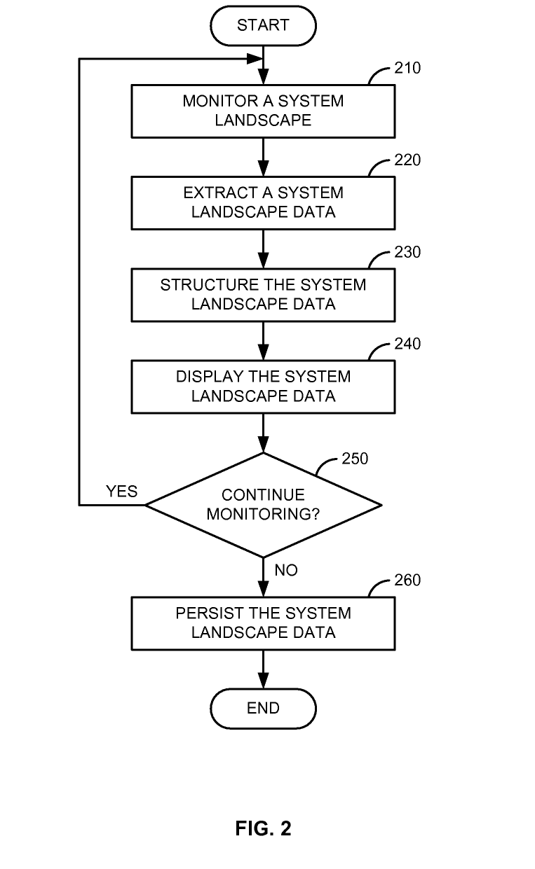

FIG. 2 is a flow diagram illustrating a method for dynamically presenting a system landscape, according to an embodiment of the invention. At process block 210, a system landscape is monitored for changes and updates. At process block 220, system landscape data is extracted from the system landscape. Further, the system landscape data is extracted using a service. At process block 230, system landscape data is structured. Further, the structured system landscape data is presented in a presentable format using the service. At process block 240, system landscape data is displayed. In an embodiment, the system landscape data is displayed using a graphical user interface by consuming the system landscape data from the service. At decision point 250, if monitoring of the system landscape is continued the process proceeds to process block 210. At decision point 250, if monitoring of the system landscape is not continued the process proceeds to process block 260. At process block 260, system landscape data is persisted. In an embodiment, the system landscape data is present in a system landscape directory.

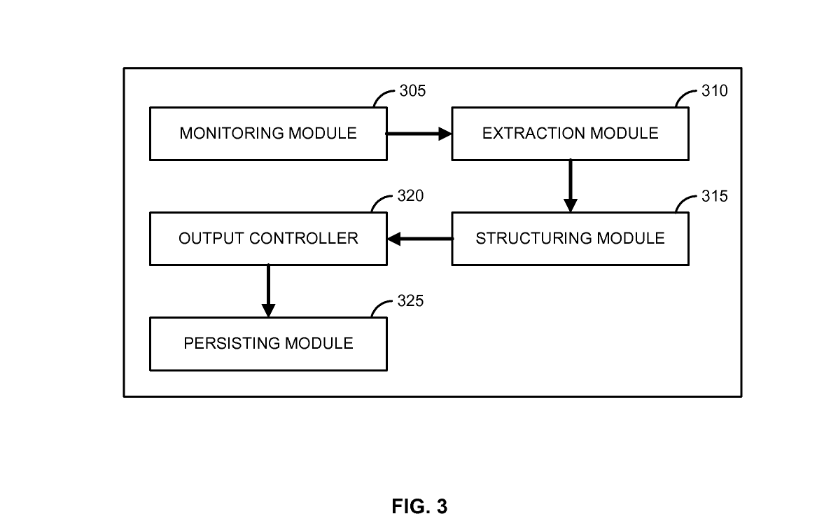

FIG. 3 is a schematic block diagram illustrating a system for dynamically presenting a system landscape, according to an embodiment of the invention.

Monitoring module 305 monitors a system landscape for changes and updates. Extraction module 310 extracts a system landscape data from the system landscape. Structuring module 315 structures and presents the system landscape data in a presentable format. Structuring module 315 constructs a context specific tree from a system landscape directory depending on varying structure and content needs of monitoring module 305 for presentation of the context specific tree. In an embodiment, the presentable format is a context specific tree with arbitrary depth. Output controller 320 outputs the presentable format of the system landscape data using a graphical user interface. Persisting module 325 persists the system landscape data. In an embodiment, the system landscape data is present in a system landscape directory. In an embodiment, multiple monitoring modules can display system landscape data present in a system landscape directory in a presentable format by using a service. In an embodiment, if different applications need to display system landscape data in different presentable formats depending on usage, multiple services can be defined depending on the requirements.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method for dynamically presenting a system landscape, comprising:
monitoring a system landscape;
extracting a system landscape data from the system landscape;
structuring the system landscape data in a presentable format; and
displaying the presentable format of the system landscape data.

2. The method in claim 1, wherein monitoring a system landscape comprises using a monitoring application.

3. The method in claim 1, wherein structuring the system landscape data in a presentable format comprises constructing a context specific tree.

4. The method in claim 1, further comprising persisting the system landscape data present in a system landscape directory.

5. The method in claim 1, wherein monitoring a system landscape comprises continuously monitoring the system landscape for changes and updates.

6. The method in claim 1, further comprising generating system landscape data using a data processing service.

7. The method in claim 6, wherein the system landscape data comprises content and is associated with a presentable format.

8. The method in claim 1, wherein displaying comprises generating a presentable format of the system landscape data in a graphical user interface.

9. The method in claim 1, wherein the presentable format comprises a generic tree structure.

10. An article of manufacture for dynamically presenting a system landscape, comprising:
a machine readable medium having instructions that when executed by a machine cause the machine to execute a method, comprising:
monitoring a system landscape;
extracting a system landscape data from the system landscape;
structuring the system landscape data in a presentable format; and
displaying the presentable format of the system landscape data.

11. The article of manufacture in claim 10, wherein monitoring a system landscape comprises using a monitoring application.

12. The article of manufacture in claim 10, wherein structuring the system landscape data in a presentable format comprises constructing a context specific tree.

13. The article of manufacture in claim 10, further comprising persisting the system landscape data present in a system landscape directory.

14. The article of manufacture in claim 10, wherein monitoring a system landscape comprises continuously monitoring the system landscape for changes and updates.

15. The article of manufacture in claim 10, further comprising generating system landscape data using a data processing service.

16. The article of manufacture in claim 10, wherein the system landscape data comprises content and is associated with a presentable format.

17. The article of manufacture in claim 10, wherein displaying comprises generating a presentable format of the system landscape data in a graphical user interface.

18. The article of manufacture in claim 10, wherein the presentable format comprises a generic tree structure.

19. A system for dynamically presenting a system landscape, comprising:
a monitoring module to monitor a system landscape;
an extraction module electronically coupled to the monitoring module to extract a system landscape data from the system landscape;
a structuring module electronically coupled to the extraction module to structure the system landscape data in a presentable format; and
an output controller electronically coupled to the structuring module to output the presentable format of the system landscape data.

20. The system in claim 19, further comprising a persisting module electronically coupled to the output controller to persist the system landscape data.
